(19) United States
(12) Patent Application Publication
(10) Pub. No.: US 2026/0061635 A1
(43) Pub. Date: Mar. 5, 2026

(54) OPHTHALMIC LENS GRIPPER

(71) Applicant: Alcon Inc., Fribourg (CH)

(72) Inventors: Nicholas Gollas, Alpharetta, GA (US); Melissa Coreen Grytdal, Suwanee, GA (US); Eduard Jetzlaff, Cumming, GA (US); David Andrew Icenogle, Brookhaven, GA (US); Cornelius Daniel Niculas, Suwanee, GA (US); Felix Brinckmann, Roßdorf (DE); Benjamin Leneschmidt, Sulzbach am Main (DE); Phil Sauerwein, Goldbach (DE); Johannes Neumann, Obernburg am Main (DE); Matthias Braun, Alpharetta, GA (US)

(21) Appl. No.: 19/311,458

(22) Filed: Aug. 27, 2025

Related U.S. Application Data
(60) Provisional application No. 63/688,410, filed on Aug. 29, 2024.

(51) Int. Cl. B25J 15/06

(52) U.S. Cl. CPC B25J 15/0683

(57) ABSTRACT

A flexible gripper head for gripping an ophthalmic lens, comprises a gripping portion arranged at a distal longitudinal end of the gripper head and comprising a convex contact surface for contacting the ophthalmic lens to be gripped, a mounting portion arranged proximal to the gripping portion, a pivot portion arranged between the mounting portion and the gripping portion, wherein the gripping portion is flexibly pivotable with respect to the mounting portion about the pivot portion, and a principal vacuum supply channel. The gripping portion comprises at least three suction openings arranged in the ophthalmic surface of the gripper head. The gripper head further comprises a plurality of secondary vacuum supply channels comprising a proximal end fluidically connected to the principal vacuum supply channel and a distal end fluidically connected to one of the at least three suction openings arranged in the convex contact surface.

### FIELD OF THE INVENTION

The present invention generally relates to the field of mass production of ophthalmic lenses, in particular contact lenses such as soft contact lenses. More specifically, it is related to a gripper head and a gripper for gripping such an ophthalmic lens.

### BACKGROUND OF THE INVENTION

Ophthalmic lenses, in particular contact lenses such as soft contact lenses, are typically manufactured in large quantities in automated lens manufacturing processes in automated lens manufacturing lines. By way of example, in the following it is referred to the manufacture of contact lenses such as soft contact lenses.

In such an automated lens manufacturing line, the lenses must be transported between different stations and/or modules of the automated lens manufacturing line. In many instances, grippers are used for this transportation.

For example, the lenses that have been extracted and treated in a treatment module comprising various chemical treatment baths (including water baths) must be transferred/transported to inspection cuvettes of a subsequent inspection module in which the lenses are optically inspected. This transfer/transportation of the lenses occurs at a transfer station where the lenses need to be transferred/transported from baskets of an uppermost treatment carrier of a stack of treatment carriers (in which the lenses are carried through the various treatment baths) into inspection cuvettes of an inspection module. Each of the baskets contains one lens that is to be transferred/transported into a corresponding inspection cuvette. Typically, a plurality of lenses is simultaneously transferred from a plurality of baskets of the treatment carrier into a corresponding plurality of inspection cuvettes-one lens from one basket into one inspection cuvette, respectively - with the aid of a corresponding plurality of grippers.

To effect transportation, the gripper picks up a lens and makes the lens adhere to the gripper by sucking the lens against a convex contact surface of the gripper head with the aid of vacuum. The gripper then moves towards the destination location with the lens adhered to the convex contact surface of the gripper, and subsequently releases the lens from the gripper at the destination location, typically by ‘blowing the lens off the gripper’ with the aid of overpressure.

A suitable gripper is described, for instance, in WO 2023/161867. Such a gripper comprises a flexible gripper head mounted to a rigid gripper shaft. The gripper head comprises a gripping portion having a convex contact surface arranged at a distal end of the gripper head. A suction opening is centrally arranged in the convex contact surface of the gripper head for vacuum to be applied through the central suction opening. For picking a lens up from a basket, the gripper is lowered to a predetermined axial position such that the gripper either touches the concave back surface of the lens to be picked up, or is arranged at a distance above the lens which is small enough such that the application of vacuum through the central suction opening makes the lens adhere against the convex contact surface of the gripper.

However, when the lens is picked up by the gripper by applying vacuum through the centrally arranged suction opening a small central portion of the lens may get sucked into the centrally arranged opening in the convex contact surface of the gripper head, which may result in the lens getting distorted and therefore negatively affecting the optical quality of the lens. Also, the lenses may get inverted upon being picked up by the gripper, i.e. flipped inside out such that the back surface of the lens (that surface of the lens intended to face the eye) is convex (instead of concave) and the front surface of the lens (that surface facing away from the eye) is concave (instead of convex). Inverted lenses must either be re-inverted in a lens re-inversion station before being transferred to a primary package, or must be discarded. This may occur in particular, but not exclusively, with toric lenses. Both, distortion and discarding of lenses lead to a reduction of the production yield. Providing a separate lens re-inversion station in the production line is costly, requires additional space in the production line and increases the overall process time needed to produce a lens. As not all types of lenses are equally prone to inversion (lenses made of some lens materials are more prone to inversion, others are less prone), a lens manufacturing line may initially not be equipped with a lens re-inversion station. Such lens manufacturing lines may not be used to produce lenses made of lens materials which are more prone to distortion or inversion, so that a simple change-over to such lens materials is not possible without additional measures being taken. Alternatively, a lens re-inversion station must be added, thus increasing costs while the risk of distortion still remains.

It is therefore an object of the invention to overcome the aforementioned disadvantages.

### SUMMARY OF THE INVENTION

In accordance with the present invention, a flexible gripper head for gripping an ophthalmic lens is suggested as it is specified by the features of the independent claim directed to the flexible gripper head. Advantageous aspects of the flexible gripper head according to the invention are the subject of the respective dependent claims. Further in accordance with the invention, a gripper comprising such gripper head is suggested.

As used in the specification including the appended claims, the singular forms “a”, “an”, and “the” include the plural, unless the context explicitly dictates otherwise. When using the term “about” with reference to a particular numerical value or a range of values, this is to be understood in the sense that the particular numerical value referred to in connection with the term “about” is included and explicitly disclosed, unless the context clearly dictates otherwise. For example, if a range of “about” numerical value A to “about” numerical value B is disclosed, this is to be understood to include and explicitly disclose a range of numerical value A to numerical value B. Also, whenever features are combined with the term “or”, the term “or” is to be understood to also include “and” unless it is evident from the specification that the term “or” must be understood as being exclusive.

According to the invention, a flexible gripper head for gripping an ophthalmic lens, in particular a contact lens such as a soft contact lens, is suggested.

The gripper head comprises:
a gripping portion arranged at a distal longitudinal end of the gripper head, the gripping portion comprising a convex contact surface for contacting the ophthalmic lens to be gripped;
a mounting portion arranged proximal to the gripping portion;
a pivot portion arranged between the mounting portion and the gripping portion, wherein the gripping portion is flexibly pivotable with respect to the mounting portion about the pivot portion; and
a principal vacuum supply channel.

The gripping portion comprises at least three suction openings arranged in the contact surface along a circle about a longitudinal axis of the gripper head, the circle having a diameter in a range of 5 millimeters to 12 millimeters, in particular 7 millimeters to 9 millimeters, and especially 8 millimeters.

The gripper head further comprises a plurality of secondary vacuum supply channels, each secondary vacuum supply channel of the plurality of secondary vacuum supply channels comprising a proximal end fluidically connected to the principal vacuum supply channel and a distal end fluidically connected to one of the at least three suction openings arranged in the convex contact surface.

According to one aspect of the gripper head according to the invention, the number of the suction openings is in the range of three to ten, in particular four to seven, and is especially five. According to another aspect of the gripper head according to the invention, the diameter of each of the at least three suction openings is in a range of 0.5 millimeters to 1.5 millimeters, and is in particular 1 millimeter.

According to yet another aspect of the gripper head according to the invention, the principal vacuum supply channel is a straight channel extending from a vacuum supply opening arranged at a proximal end of the mounting portion of the gripper head along the longitudinal axis of the gripper head.

According to a further aspect of the gripper head according to the invention, the gripping portion comprises a plurality of grooves arranged in the convex contact surface, each groove extending from one of the at least three suction openings in a direction outwardly away from the longitudinal axis of the gripper head.

According to another aspect of the gripper according to the invention, each of the grooves arranged in the convex contact surface has a length in a range of 0.5 millimeters to 1.5 millimeters, in particular 1 millimeter.

According to yet another aspect of the gripper head according to the invention, the convex contact surface comprises a central portion which is closed.

According to a further aspect of the gripper head according to the invention,
the gripping portion further comprises a central suction opening centrally arranged in the convex contact surface,
and the gripper head further comprises a central secondary vacuum supply channel comprising a proximal end fluidically connected to the principal vacuum supply channel and a distal end fluidically connected to the central suction opening.

According to another aspect of the gripper according to the invention, the gripper head is made of silicone.

According to another aspect of the invention, a gripper for gripping an ophthalmic lens, in particular a contact lens such as a soft contact lens is suggested.

The gripper comprises
a rigid gripper shaft comprising a shaft vacuum supply channel extending through the gripper shaft; and
a gripper head as described above, the mounting portion of which is mounted to the gripper shaft at a distal end portion of the gripper shaft, wherein the principal vacuum supply channel of the gripper head is fluidically connected with the shaft vacuum supply channel.

The gripper head according to the invention offers a number of advantages. Through the arrangement of the suction openings in the contact surface it is avoided that a central portion of the lens gets sucked into a (single) centrally arranged suction opening upon being gripped by the gripper, as this was the case with the prior art gripper discussed above. Rather, the lens is sucked against the convex contact surface by vacuum supplied to the at least three suction openings arranged (off-center) in the convex contact surface along a circle about the longitudinal axis. The arrangement of the suction openings along the circle with a diameter in the above-mentioned range about the longitudinal axis of the gripper head makes sure the suction force is applied off-center. Thus, the risk that the lens is getting inverted, i.e. flipped “inside out” such that the front surface of the lens is concave (instead of convex) and the back surface of the lens is convex (instead of concave) is greatly reduced. Furthermore, the risk that the ophthalmic lens is getting distorted is significantly reduced, too. Thus, the risk of a negative impact on the optical properties of the lens which may be caused by said distortions, is reduced, too. As a consequence, any negative impact on the production yield caused by distortion and/or inversion of the lens is greatly reduced. In addition, it may even be possible to completely avoid the provision of a lens re-inversion station, irrespective of the lens material the lens is made of, thus saving cost and process time.

Typically, a plurality of lenses are gripped simultaneously from a plurality of baskets of a treatment carrier. A flexible gripper head having a gripping portion that is flexibly pivotable with respect to the mounting portion is advantageous in case the longitudinal axis of the gripper head is slightly displaced laterally (i.e. in a direction perpendicular to the longitudinal axis of the gripper head) from a center of the corresponding basket of the treatment carrier. It is also advantageous in case the lens to be gripped is arranged off-center in the basket of the treatment carrier. When the gripper head is moved axially (i.e. in a direction along the longitudinal axis of the gripper head) towards the lens, in both scenarios an off-center portion of the contact surface of the gripping portion initially contacts an off-center portion of the concave back surface of the lens. When the gripper head is then further moved axially downwards, the gripping portion of the gripper head is pivoted such that the lateral position of the gripping portion adapts to the lateral position of the lens, so that essentially the entire convex contact surface of the gripping portion of the gripper head contacts the concave back surface of the lens.

The shape of the gripper head may be rotationally symmetric and the pivot portion may be that portion of the gripper head having the smallest diameter, and this pivot portion is arranged between the mounting portion and the gripping portion of the gripper head. The gripper head may further comprise a distal conical portion arranged between the pivot portion and the gripping portion, and this distal conical portion tapers from a largest diameter of the gripping portion towards the pivot portion. The gripper head may further comprise a proximal conical portion arranged between the mounting portion and the pivot portion, and this proximal conical portion tapers from a largest diameter of the mounting portion towards pivot portion. The pivot portion may for instance be cylindrically shaped.

Each of the secondary vacuum supply channels may be a straight channel and may have an inner diameter which is the same as the diameter of the suction opening at which the respective secondary vacuum supply channel terminates and to which the respective vacuum supply channel is fluidically connected. The sum of the cross-sectional areas of all secondary vacuum supply channels is equal to (or larger than) the cross-sectional area of the principal vacuum supply channel. The principal vacuum supply channel and the secondary vacuum supply channel are suitable to supply not only vacuum, but also to supply overpressure.

The suction openings may be arranged equidistantly along the circle about the longitudinal axis (i.e. viewed in circumferential direction). Such an arrangement is advantageous to avoid inversion of the lens upon being gripped by the gripper. In such an arrangement, the suction forces acting on the lens through the suction openings in the convex contact surface are applied symmetrically with respect to the center of the lens.

While generally the number of the suction openings is not limited, an exemplary number of openings is in the range of three to ten, in particular in the range of four to seven, and is especially five. These numbers are advantageous in that they allow for an equidistant distribution of the suction openings along the circle, wherein at the same time each of the suction openings and thus also the secondary vacuum supply channels may have a diameter such that they spatially do not conflict with one another and at the same time allow the application of sufficient vacuum to make the lens adhere to the convex contact surface of the gripping portion.

A typical for the diameter of each of the suction openings is 0.5 millimeters to 1.5 millimeters, and in particular the diameter may be 1 millimeter. Said range allows on the one hand to supply strong enough a suction to make the lens adhere to the convex contact surface of the gripper head. On the other hand, suction openings having a diameter in the afore-mentioned range are small enough to prevent distortion of the lens as the lens is sucked against the convex contact surface.

The plurality of grooves arranged in the contact surface are advantageous in that the area in which vacuum is applied to the concave back surface of the lens to be gripped is increased. Thus, adhesion of the lens to the convex contact surface of the gripper head is increased. The direction of extension of each groove outwardly away from the longitudinal axis of the gripper head is particularly efficient to increase adhesion of the lens to the convex contact surface of the gripper head as well as for avoiding lens inversion. However, it is also possible that no grooves are present in the contact surface at all (e.g. to reduce potential bioburden).

A typical length of a said groove may be in a range of 0.5 millimeters to 1.5 millimeters, and in particular the length of a said groove may be 1 millimeter. This is efficient for increasing adhesion of the lens to the convex contact surface of the gripper head. The groove may have a depth in a range of 0.2 millimeters to 0.6 millimeters and a width less than the diameter of the respective suction opening. Such width may, for example, be in the range of 0.2 millimeters to 1.0 millimeter.

When the convex contact surface is closed at a central portion thereof, this means that it is devoid of any suction openings in the said central portion. The central portion of the convex contact surface is a portion around an intersection point of the longitudinal axis of the gripper head with the convex contact surface, and this central portion is encircled by that circle along which the suction openings are arranged. More frankly speaking, this means that no suction openings are arranged in a portion encircled by that circle along which the suction openings are arranged. A convex contact surface having a closed central portion is advantageous in that the risk of lens inversion is minimized. As the lens is pulled towards the convex contact surface only via the suction openings arranged along the circle about the longitudinal axis of the gripper head, no force is applied to a more central portion of the lens, thus avoiding both lens inversion and lens distortion.

Alternatively, the gripping portion may comprise central suction opening in addition to the suction openings arranged (off-center) along the circle about the longitudinal axis of the gripper head in order to increase the suction and thus the adhesion of the lens against the convex contact surface of the gripping portion of the gripper head. At the same time, the risk of lens inversion of the lens is still greatly reduced by the suction openings arranged along the circle about the longitudinal axis of the gripper head.

While generally a number of flexible materials are contemplated from which the gripper head may be made, silicone is a material that provides the required flexibility, is suitable for an ophthalmic lens manufacturing line, and allows for a simple and reliable manufacture of the gripper head (e.g. using molding techniques).

Generally, the gripper according to the invention may be embodied similar to the gripper described in WO 2023/161867, however the gripper of the instant invention is equipped with the gripper head according to the invention.

For instance, the gripper may further comprise a support movably accommodating the gripper shaft as well as a spring biasing the gripper shaft distally away from the support in a direction of a longitudinal shaft axis of the gripper shaft. Moreover, the gripper may comprise a connector arranged at proximal end of the gripper shaft and a vacuum supply channel extending through the gripper shaft in the direction of the longitudinal axis of the gripper shaft. In addition, the gripper may comprise a connector arranged at a proximal end of the gripper shaft to connect a flexible supply tube at the proximal end of the gripper shaft such that vacuum or overpressure may be supplied.

### BRIEF DESCRIPTION OF THE DRAWINGS

Further advantageous aspects of the invention become apparent from the following description of embodiments of the invention with the aid of the (schematic) drawings, in which:

FIG. 1 shows a side view of a first embodiment of a gripper head according to the invention;

FIG. 2 shows a perspective view of the first embodiment of the gripper head shown in FIG. 1;

FIG. 3 shows a bottom view of the first embodiment of the gripper head shown in FIG. 1;

FIG. 4 shows a top view of the first embodiment of the gripper head shown in FIG. 1;

FIG. 5 shows a perspective view of a first embodiment of a gripper according to the invention together with a treatment carrier and a lens prior to being gripped by the gripper;

FIG. 6 shows a top view of the first embodiment of the gripper of FIG. 5 together with a treatment carrier;

FIG. 7 shows a cross-sectional view of the gripper and the treatment carrier along the line VII-VII in FIG. 6;

FIG. 8 shows enlarged view of the detail VIII of FIG. 7;

FIG. 9 shows the enlarged cross-sectional view also shown in FIG. 8, after the lens has been gripped by the gripper;

FIG. 10 shows a side view of a second embodiment of the gripper head according to the invention;

FIG. 11 shows a perspective view of the second embodiment of the gripper head shown in FIG. 10;

FIG. 12 shows a bottom view of the second embodiment of the gripper head shown in FIG. 10;

FIG. 13 shows a top view of the second embodiment of the gripper head shown in FIG. 10; and

FIG. 14 shows a cross-sectional view of a second embodiment of the gripper according to the invention together with a treatment carrier and with a lens being gripped by the gripper.

### DETAILED DESCRIPTION OF EMBODIMENTS

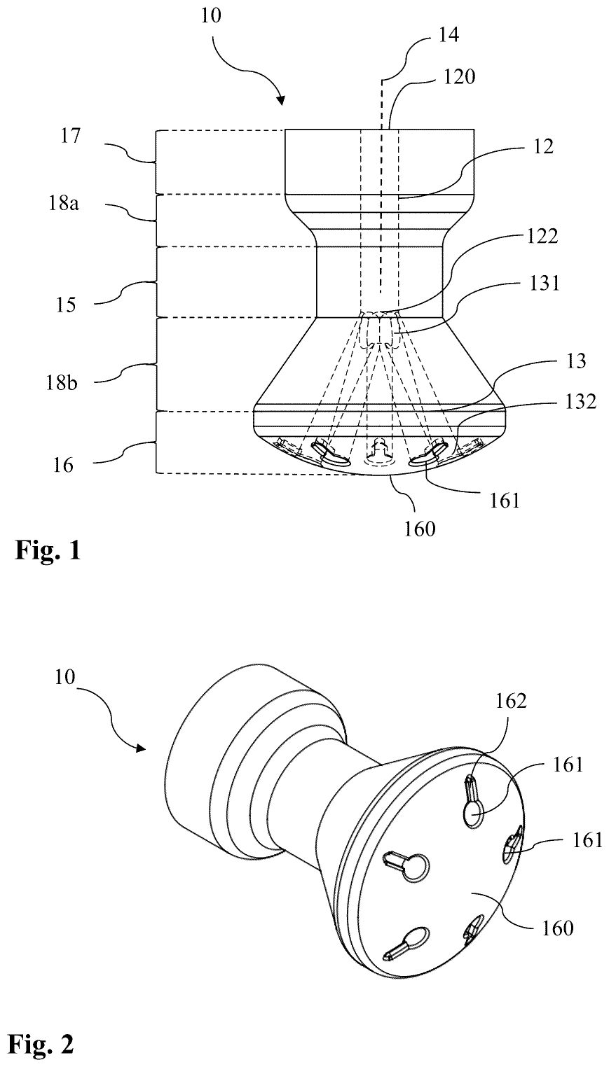

FIG. 1 shows a side view of a first embodiment of a gripper head 10 according to the invention. Gripper head 10 is made of one piece of a flexible material, for example silicone, and its shape is rotationally symmetric about a longitudinal axis 14. Gripper head 10 comprises a mounting portion 17, a gripping portion 16 comprising a convex contact surface 160, and a pivot portion 15. Mounting portion 17 is arranged proximal to gripping portion 16, and pivot portion 15 is arranged between gripping portion 16 and mounting portion 17.

Gripper head 10 further comprises a proximal conically shaped portion 18a arranged between pivot portion 15 and mounting portion 17. Proximal conically shaped portion 18a tapers from a largest diameter at mounting portion 17 to a smallest diameter of pivot portion 15. Gripper head 10 further comprises a distal conically shaped portion 18b arranged between pivot portion 15 and gripping portion 16. Distal conically shaped portion 18b tapes from a largest diameter at gripping portion 16 towards a smallest diameter at pivot portion 15. Pivot portion 15 is cylindrically shaped and is that portion having the smallest diameter of gripper head 10, such that gripping portion 16 is pivotable with respect to mounting portion 17 about pivot portion 15.

The gripper head 10 further comprises a principal vacuum supply channel 12 which is embodied as a straight channel extending from a vacuum supply opening 120 arranged at a proximal end of mounting portion 17 along longitudinal axis 14, as indicated in FIG. 1 by dashed lines. Vacuum supply opening 120 may be connected to a vacuum supply tube of a gripper shaft to which gripper head 10 may be mounted at mounting portion 17 of gripper head 10. In addition, gripper head 10 comprises a plurality of secondary vacuum supply channels 13. The number of secondary vacuum supply channels 13 of the plurality of secondary vacuum supply channels 13 is five in the embodiment shown in FIG. 1, but may alternatively be any number in a range of three to ten, in particular four to seven. Each of the secondary vacuum supply channels 13, at a respective proximal end 131 thereof, is fluidically connected to the principal vacuum supply channel 12. The secondary vacuum supply channels 13 branch off from the principal vacuum supply channel 12 at a distal end of principal vacuum supply channel 12.

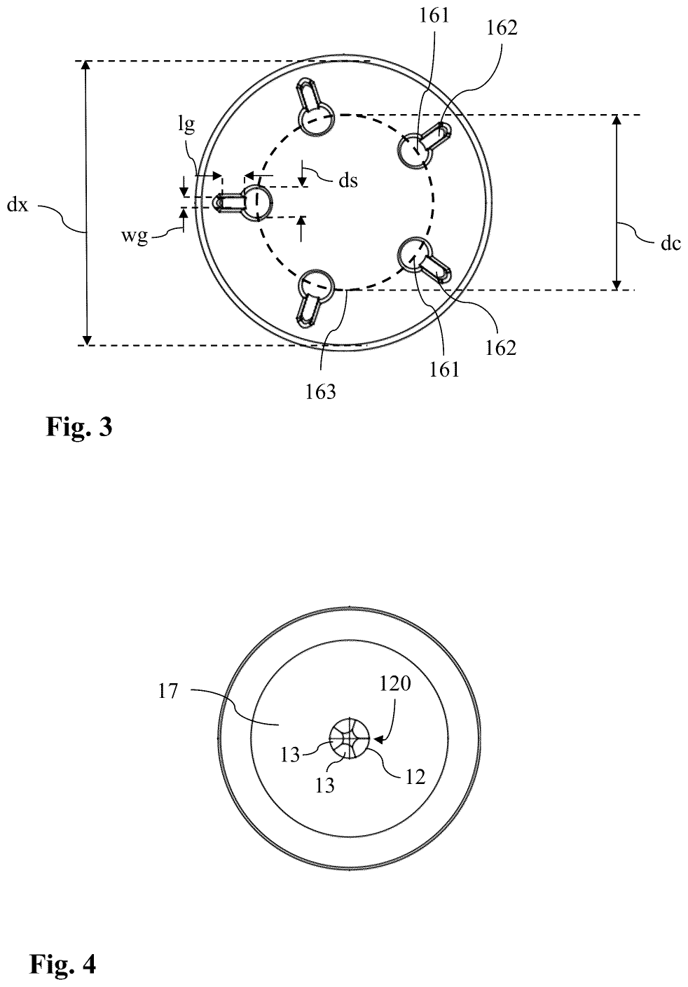

As can be seen best in the perspective view of gripper head 10 shown in FIG. 2 and the bottom view shown in FIG. 3, gripping portion 16 comprises a plurality of suction openings 161 arranged in the convex contact surface 160 of gripper head 10. The number of suction openings 161 is the same as the number of secondary vacuum supply channels 13. Each of the suction openings 161 is fluidically connected with a distal end 132 of an associated one of the secondary vacuum supply channels 13. Suction openings 161 are arranged along a circle 163 about longitudinal axis 14, this circle 163 having a diameter dc in a range of five millimeters to twelve millimeters, in particular seven millimeters to nine millimeters, and especially eight millimeters. Suction openings 161 are arranged equidistantly with respect to a circumferential direction of the circle 163. Each of the suction openings 161 has an opening diameter ds in the range of half a millimeter to one and a half millimeters, and in particular one millimeter. Convex contact surface 160 has a diameter dx in the range of 7 millimeters to 17 millimeters, in particular in the range of 10 millimeters to 12 millimeters.

A plurality of grooves 162 are arranged in the convex contact surface 160 of gripper head 10. Each groove 162 extends from a respective suction opening 161 in a direction outwardly away from longitudinal axis 14 of gripper head 10, and has a length lg in a range of half a millimeter to one and a half millimeters, in particular one millimeter. The depth of each groove 162 is in a range of 0.2 millimeters to 0.6 millimeters. A width wg of each groove 162 is in the range of 0.2 millimeters to 1.0 millimeters.

As can be seen best in the top view of gripper head 10 shown in FIG. 4, the principal vacuum supply channel 12 branches off into the plurality of secondary vacuum supply channels 13.

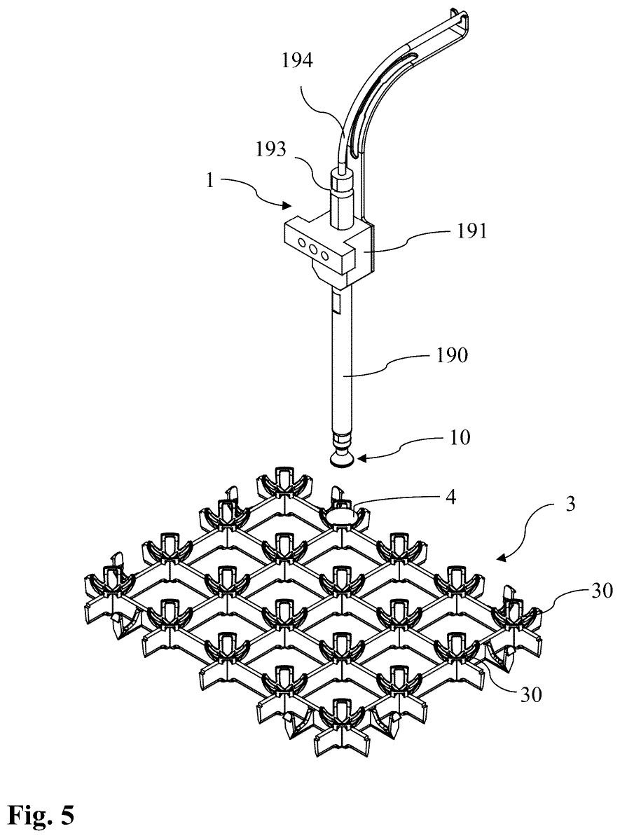

FIG. 5 shows a first embodiment of a gripper 1 according to the invention. The gripper 1 comprises the first embodiment of gripper head 10 described above.

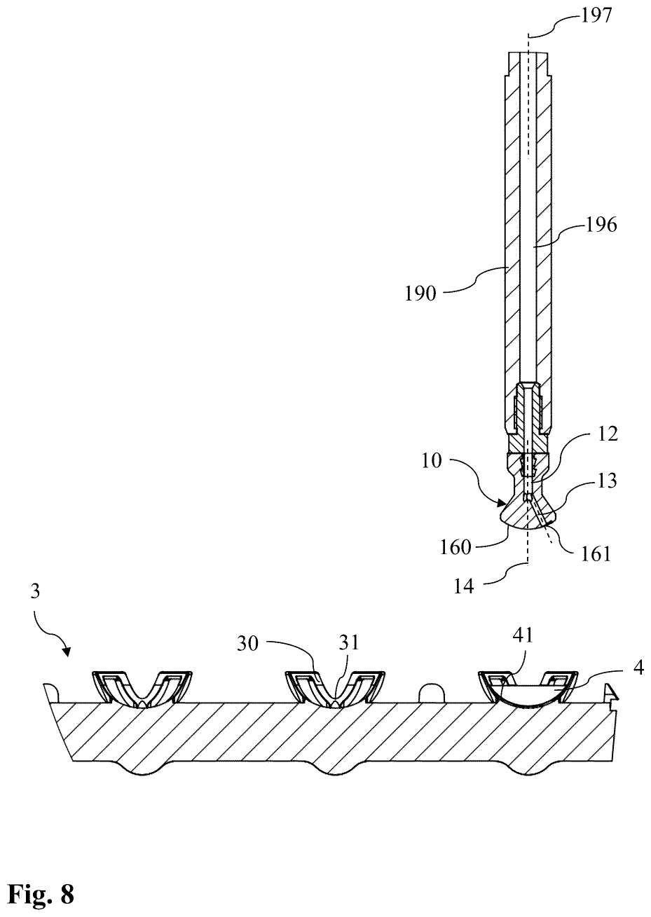

Gripper 1 further comprises a rigid gripper shaft 190 comprising a vacuum supply channel extending longitudinally within gripper shaft 190. Gripper head 10 is mounted to gripper shaft 190 at a distal end of gripper shaft 190. Gripper shaft 190 is movably accommodated by a support 191. Gripper 1 further comprises a connector 193 which is arranged at a proximal end of gripper shaft 190. Connector 193 connects a flexible vacuum supply tube 194 to a vacuum supply channel 196 (not visible in FIG. 5, see FIG. 8) of gripper shaft 190 in a fluid-tight manner, such that vacuum can be provided to vacuum supply channel 196 of gripper shaft 190 (and thus to principal vacuum supply channel 12 of gripper head 10) via flexible vacuum supply tube 194.

Gripper 1 is essentially identical to the gripper described in WO 2023/161867, with the exception that gripper 1 is provided with gripper head 10 according to the invention instead of that gripper head disclosed in WO 2023/161867.

FIG. 5 further shows a treatment carrier 3 comprising a plurality of treatment baskets 30, wherein each of the treatment baskets 30 may accommodate an ophthalmic lens, in particular a contact lens 4 such as a soft contact lens. The lenses arranged in the plurality of treatment baskets 30 may be submerged in one or more treatment liquids of a chemical treatment unit of a lens manufacturing line. A plurality of treatment carriers 3 may be stacked on top of each other to form a stack of treatment carriers 3. In such case, the lenses 4 are picked up by gripper 1 from the uppermost treatment carrier 3 of the stack, and once all lenses are removed from the uppermost carrier 3 of the stack, the uppermost treatment carrier is removed as well, whereupon the lenses are removed from the next treatment carrier 3 (now being the uppermost treatment carrier 3). In the treatment carrier 3 shown in FIG. 5, by way of example one lens 4 is shown arranged in one of the treatment baskets 30 for illustrative purposes. In practice, typically one lens 4 is arranged in each of the treatment baskets 30 of treatment carrier 3. A plurality of lenses 4 arranged in the plurality of treatment baskets 30 may be simultaneously gripped by a plurality of grippers 1, for example the lenses 4 of one row or one column of baskets 30 of a said treatment carrier 3 may be simultaneously gripped by a corresponding number of grippers 1.

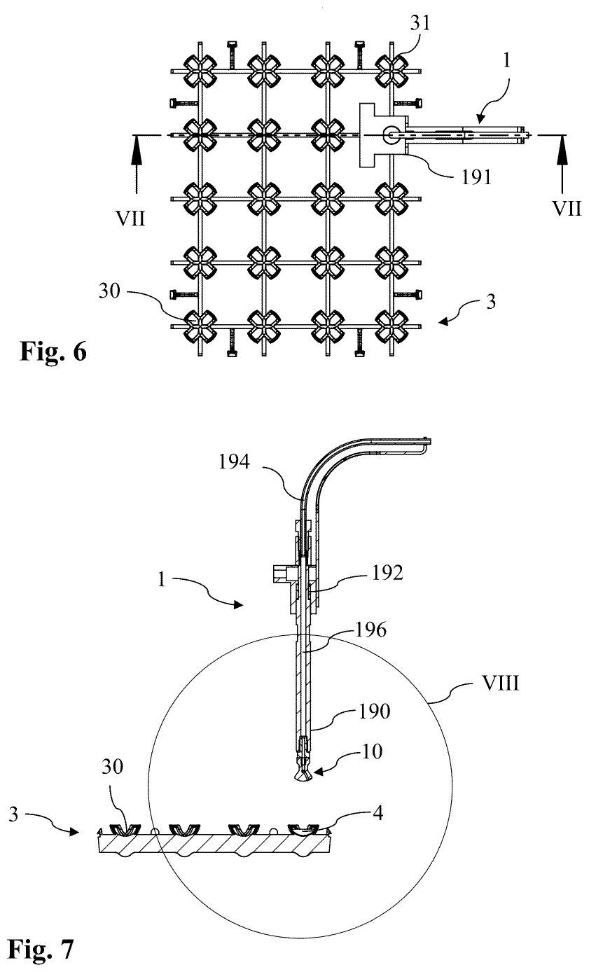

In the scenario shown in FIG. 5, the lens 4 is still arranged in the treatment basket 30 prior to being gripped by gripper 1. As can be seen in the top view of gripper 1 and treatment carrier 3 shown in FIG. 6, gripper 1 is arranged above lens 4 contained in treatment carrier 2 prior to gripping.

FIG. 7 shows a cross-sectional view of gripper 1 and treatment carrier 3 along line VII-VII shown in FIG. 6. FIG. 8 shows an enlarged view of detail VIII of FIG. 7. In both, FIG. 7 and FIG. 8, the lens 4 to be gripped by gripper 1 is still arranged in treatment basket 30 of treatment carrier 3 prior to being gripped by gripper 1. Gripper 1 is arranged such that the longitudinal axis 14 of gripper head 10 is (laterally) aligned with a basket center 31 of an associated one of the treatment baskets 30. Gripper shaft 190 with gripper head 10 mounted thereto is then lowered until convex contact surface 160 of gripper head 10 contacts the back surface 41 of lens 4, or is lowered down such that a vertical distance between back surface 41 of lens 4 and convex contact surface 160 of gripper head 10 is small enough such that that the application of vacuum through the secondary vacuum supply channels 13 makes the lens adhere to convex contact surface 160 of gripper head 10. A spring 192 may be mounted between support 191 and gripper shaft 190, as this is described in more detail in WO 2023/161867.

A longitudinal shaft axis 197 of gripper shaft 190 coincides with longitudinal axis 14 of gripper head 10. Longitudinal shaft axis 197 and longitudinal axis 14 of gripper head 10 are both aligned with a basket center 31 of the associated treatment basket 30 to grip the lens 4 arranged in treatment basket 30.

Vacuum may be provided to suction openings 161 in convex contact surface 160 of gripper head 10 by a suitable vacuum pump via flexible vacuum supply tube 194, vacuum supply channel 196 of the gripper shaft 190, principal vacuum supply channel 12 of the gripper head 10 and secondary vacuum supply channels 13.

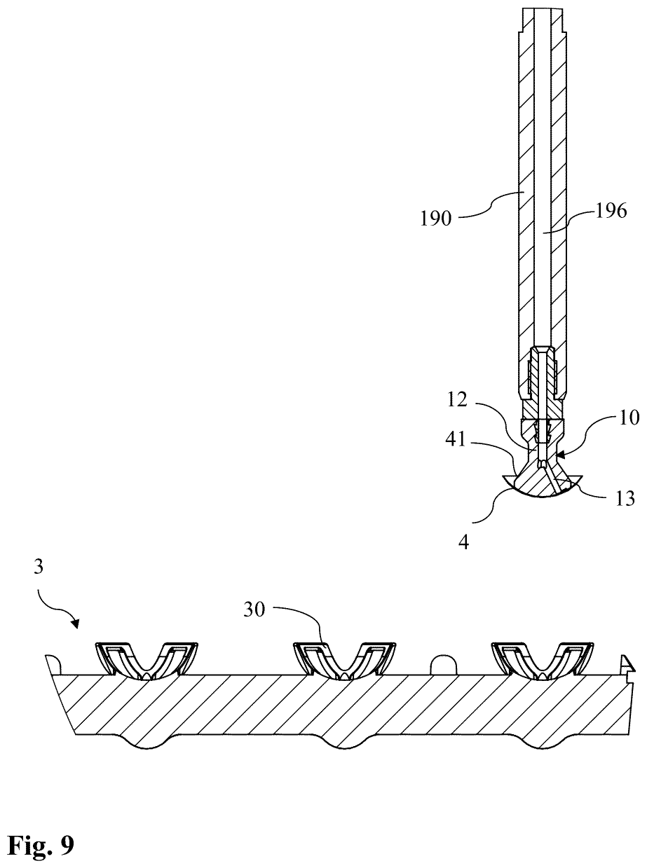

FIG. 9 shows the same cross-sectional view as that shown in FIG. 8, however with lens 4 being gripped by gripper 1 (i.e. adhering to convex contact surface 160 of gripper head 10). Vacuum is maintained through secondary vacuum supply channels 13 to maintain lens 4 adhered to convex contact surface 160. Only one secondary vacuum supply channel 13 of gripper head 10 is visible in the cross-sectional view of FIG. 9.

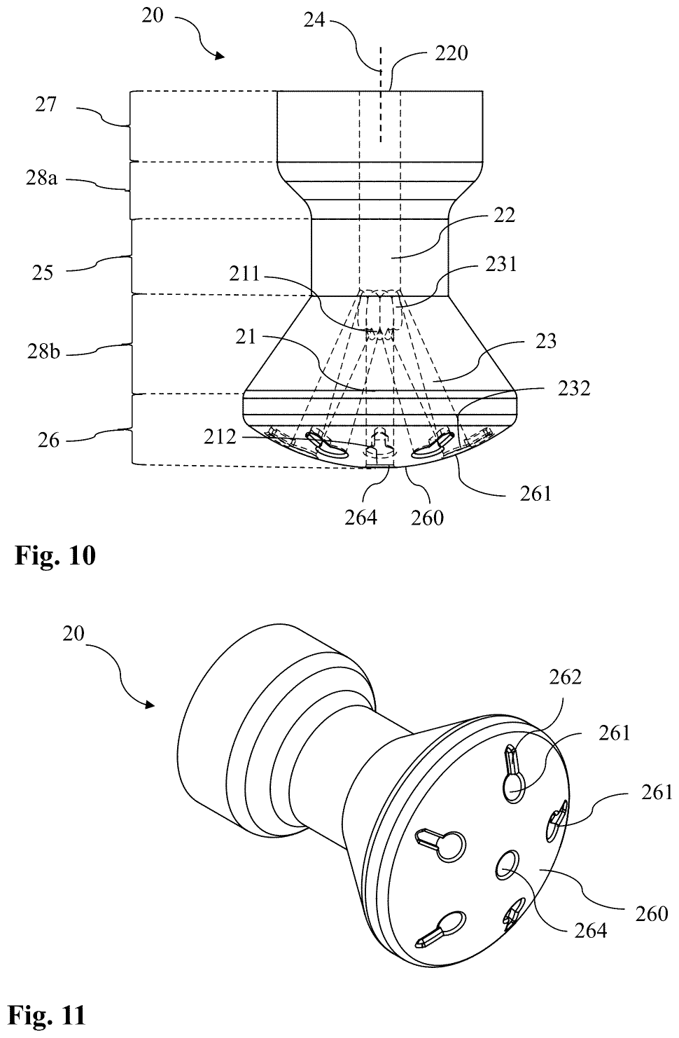

FIG. 10 shows a side view of a second embodiment of a gripper head 20 according to the invention. Again, gripper head 20 is embodied as one piece made of a flexible material, for example silicone, and its shape is rotationally symmetric about a longitudinal axis 24. Gripper head 20 comprises a mounting portion 27, a gripping portion 26 comprising a convex contact surface 260, and a pivot portion 25. Mounting portion 27 is arranged proximal to gripping portion 26, and pivot portion 25 is arranged between gripping portion 26 and mounting portion 27.

Gripper head 20 further comprises a proximal conically shaped portion 28a arranged between pivot portion 25 and mounting portion 27, tapering from a largest diameter at mounting portion 27 towards a smallest diameter at pivot portion 25. Gripper head 20 further comprises a distal conically shaped portion 28b arranged between pivot portion 25 and gripping portion 26. Pivot portion 25 is cylindrically shaped and is that portion having the smallest diameter of gripper head 20, such that gripping portion 26 is pivotable with respect to mounting portion 27 about pivot portion 25.

Gripper head 20 further comprises a principal vacuum supply channel 22 which is a straight channel extending from a vacuum supply opening 220 arranged at a proximal end of mounting portion 27 along longitudinal axis 24, as indicated in FIG. 10 by dashed lines. Vacuum supply opening 220 may be connected to a vacuum supply tube of a gripper shaft to which gripper head 20 may be mounted at mounting portion 27 of gripper head 20. In addition, gripper head 20 comprises a plurality of secondary vacuum supply channels 23. The number of secondary vacuum supply channels 23 is five in the present embodiment 5, but may alternatively be any number in a range of three to ten, in particular four to seven. Each of the secondary vacuum supply channels 23, at a proximal end 231 thereof, is fluidically connected to principal vacuum supply channel 22. Secondary vacuum supply channels 23 branch off from principal vacuum supply channel 22 at a distal end of principal vacuum supply channel 22.

In addition to the five secondary vacuum supply channels 23, gripper head 20 comprises a central secondary vacuum supply channel 21 extending from the principal vacuum supply channel 22 along longitudinal axis 24. A proximal end 211 of central secondary vacuum supply channel 21 fluidically connected to principal vacuum supply channel 22.

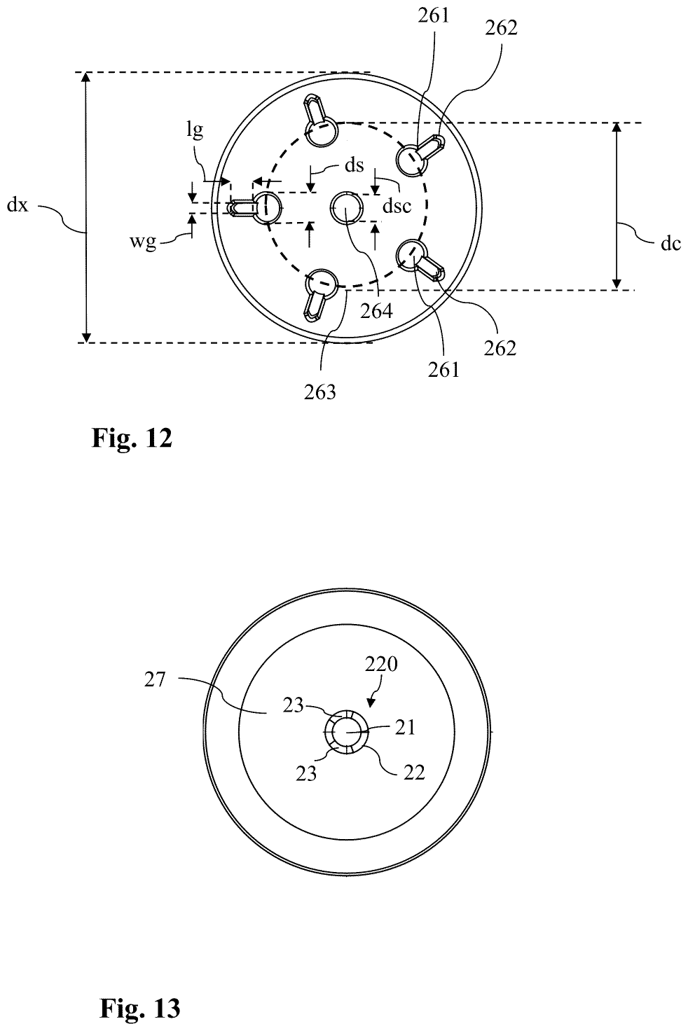

As can be seen best in the perspective view of the second embodiment of gripper head 20 shown in FIG. 11 and the bottom view shown in FIG. 12, gripping portion 26 comprises a plurality of suction openings 261 arranged in the convex contact surface 260 along a circle 263 about longitudinal axis 24. The number of suction openings 261 arranged along circle 263 is five in the second embodiment of gripper head 20, but may alternatively be any number in a range of three to ten, in particular four to seven, and is the same as the number of secondary vacuum supply channels 23. Each of the suction openings 261 is fluidically connected with a distal end 232 of one of the secondary vacuum supply channels 23. Circle 263 along which suction openings 261 are arranged has a diameter dc in a range of five millimeters to twelve millimeters, in particular seven millimeters to nine millimeters, especially eight millimeters. Suction openings 261 are arranged equidistantly in a circumferential direction along circle 263. Each of the suction openings 261 has an opening diameter ds in the range of half a millimeter to one and a half millimeters, and in particular one millimeter. The convex contact surface 260 has a diameter dx in the range of 7 millimeters to 17 millimeters, in particular in the range of 10 millimeters to 12 millimeters.

A plurality of grooves 262 is arranged in convex contact surface 260. Each groove 262 extends from one suction opening 261 in a direction outwardly away from longitudinal axis 24, and has a length in a range of half a millimeter to one and a half millimeters, in particular one millimeter. The depth of each groove 262 is in a range of 0.2 millimeters to 0.6 millimeters.

In addition to the five suction openings 261 arranged along circle 263, gripping portion 26 comprises a central suction opening 264 arranged in convex contact surface 260. Central suction opening 264 is fluidically connected to a distal end 212 of central secondary vacuum supply channel 21. Central suction opening 264 has an opening diameter dsc which is in the range of half a millimeter to one and a half millimeters, and in particular one millimeter.

As can be seen in the top view of the gripper head 20 shown in FIG. 13, principal vacuum supply channel 22 branches off into both the secondary vacuum supply channels 23 and the central secondary vacuum supply channel 21.

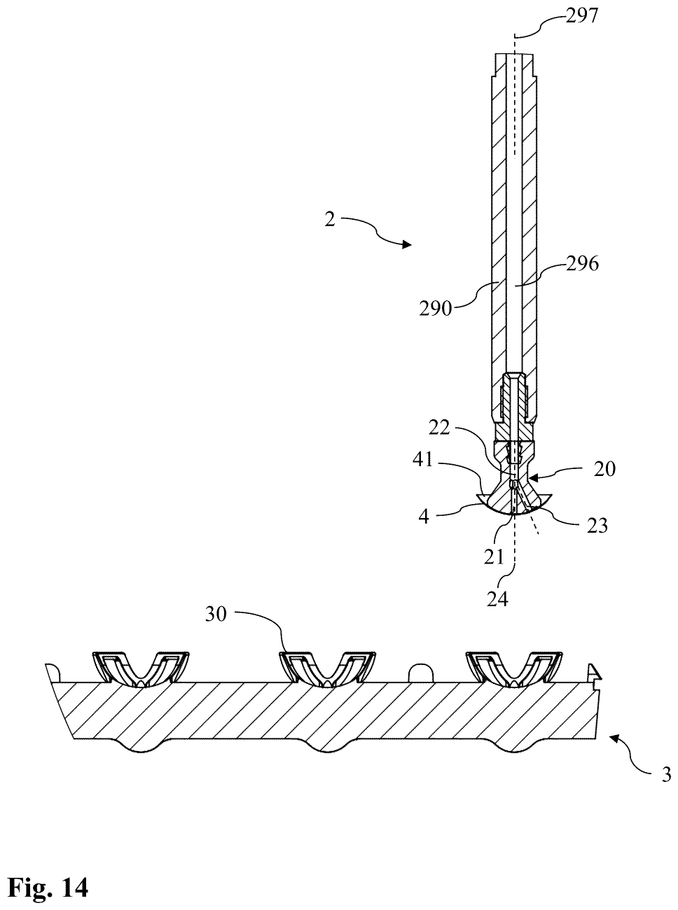

FIG. 14 shows a cross-sectional view of a second embodiment the gripper 2 according to the invention and the treatment carrier 3 already shown in cross-sectional view in FIG. 9. The lens 4 is being gripped by the gripper 2 and adheres with the back surface 41 of the lens 4 to convex contact surface 260 of gripper head 20 of gripper 2. The second embodiment of the gripper 2 according to the invention is identical to the first embodiment of gripper 1 except that the second embodiment of gripper 2 comprises the second embodiment of gripper head 20 instead of the first embodiment of gripper head 10. Therefore, a detailed description of the second embodiment of gripper 2 are not described in detail again. Reference numbers of the elements of the second embodiment of the gripper 2 have a leading number ‘2’ instead of the leading number '1′of the first embodiment of the gripper 1.

For gripping a lens 4, gripper shaft 290 of gripper 2 with gripper head 20 mounted thereto is lowered until the convex contact surface 260 contacts the back surface 41 of lens 4, or is lowered down to a vertical distance between lens 4 and convex contact surface 260 that is small enough such that the application of vacuum through secondary vacuum supply channels 23 and central secondary vacuum supply channel 21 makes the lens 4 adhere to the convex contact surface 260 of gripper head 20.

The vacuum may be provided to suction openings 261 and central suction opening 264 arranged in convex contact surface 260 of gripper head 20 by a suitable vacuum pump via flexible vacuum supply tube (not shown) of gripper 2, vacuum supply channel 296 of gripper shaft 290, principal vacuum supply channel 22 of gripper head 20 and secondary vacuum supply channels 23 as well as via central secondary vacuum supply channel 21, similar as that has been described above for the first embodiment of gripper 1.

Embodiments of the invention have been described with the aid of the drawings. However, the invention is not limited to these embodiments. Rather, various changes and modifications can be made without departing from the teaching underlying the invention. The scope of protection is therefore defined by the appended claims.

1. Flexible gripper head (10, 20) for gripping an ophthalmic lens (4), in particular a contact lens such as a soft contact lens,
the gripper head (10, 20) comprising:
a gripping portion (16, 26) arranged at a distal longitudinal end of the gripper head (10, 20), the gripping portion comprising a convex contact surface (160, 260) for contacting the ophthalmic lens (4) to be gripped;
a mounting portion (17, 27) arranged proximal to the gripping portion (16, 26);
a pivot portion (15, 25) arranged between the mounting portion (17, 27) and the gripping portion (16, 26), wherein the gripping portion (16, 26) is flexibly pivotable with respect to the mounting portion (17, 27) about the pivot portion (15, 25); and
a principal vacuum supply channel (12, 22);
wherein
the gripping portion (16, 26) comprises at least three suction openings (161, 261) arranged in the contact surface (160, 260) along a circle (163, 263) about a longitudinal axis (14, 24) of the gripper head (10, 20), the circle (163, 263) having a diameter (dc) in a range of 5 millimeters to 12 millimeters, in particular 7 millimeters to 9 millimeters, and especially 8 millimeters;
and wherein
the gripper head (10, 20) further comprises a plurality of secondary vacuum supply channels (13, 23), each secondary vacuum supply channel (13, 23) of the plurality of secondary vacuum supply channels comprising a proximal end (131, 231) fluidically connected to the principal vacuum supply channel (12, 22) and a distal end (132, 232) fluidically connected to one of the at least three suction openings (161, 261) arranged in the convex contact surface (160, 260).

2. Gripper head (10, 20) according to claim 1, wherein the number of the suction openings (161, 261) is in the range of 3 to 10, in particular 4 to 7, and is especially 5.

3. Gripper head according to claim 1, wherein the diameter (ds) of each of the at least three suction openings (161, 162) is in a range of 0.5 millimeters to 1.5 millimeters, and is in particular 1 millimeter.

4. Gripper head according to claim 1, wherein the principal vacuum supply channel (12, 22) is a straight channel extending from a vacuum supply opening (120, 220) arranged at a proximal end of the mounting portion (17, 27) of the gripper head along the longitudinal axis of the gripper head.

5. Gripper head according to claim 1, wherein the gripping portion (16, 26) comprises a plurality of grooves (162, 262) arranged in the convex contact surface (160, 260), each groove (162, 262) extending from one of the at least three suction openings (161, 261) in a direction outwardly away from the longitudinal axis (14, 24) of the gripper head (10, 20).

6. Gripper head (10, 20) according to claim 5, wherein each of the grooves (161, 262) arranged in the convex contact surface (160, 260) has a length (lg) in a range of 0.5 millimeters to 1.5 millimeters, in particular 1 millimeter.

7. Gripper head (10) according to claim 1, wherein the convex contact surface (160) comprises a central portion which is closed.

8. Gripper head (20) according to claim 1,
wherein the gripping portion (26) further comprises a central suction opening (264) centrally arranged in the convex contact surface (260),
and wherein the gripper head (20) further comprises a central secondary vacuum supply channel (21) comprising a proximal end (211) fluidically connected to the principal vacuum supply channel (22) and a distal end (212) fluidically connected to the central suction opening (264).

9. Gripper head (10, 20) according to claim 1, wherein the gripper head (10, 20) is made of silicone.

10. Gripper (1, 2) for gripping an ophthalmic lens (4), in particular a contact lens such as a soft contact lens, the gripper comprising
a rigid gripper shaft (190, 290) comprising a shaft vacuum supply channel (196, 296) extending through the gripper shaft (190, 290);
a gripper head (10, 20) according to claim 1 the mounting portion (17, 27) of which is mounted to the gripper shaft (190, 290) at a distal end portion of the gripper shaft (190, 290), wherein the principal vacuum supply channel (12, 22) of the gripper head (10, 20) is fluidically connected with the shaft vacuum supply channel (196, 296).
